(19) United States
(12) Patent Application Publication
(10) Pub. No.: US 2026/0052183 A1
(43) Pub. Date: Feb. 19, 2026

(54) Acoustic Optimizations for Extended Reality Experiences

(71) Applicant: Apple Inc., Cupertino, CA (US)

(72) Inventors: Camellia G. Boutros, San Francisco, CA (US); Christopher T. Eubank, Santa Barbara, CA (US); Mitchell R. Lerner, San Francisco, CA (US); Juha O. Merimaa, San Mateo, CA (US); Martin E. Johnson, Los Gatos, CA (US)

(21) Appl. No.: 19/240,451

(22) Filed: Jun. 17, 2025

Related U.S. Application Data
(60) Provisional application No. 63/683,564, filed on Aug. 15, 2024.

(51) Int. Cl. H04L 67/131; G06F 3/16

(52) U.S. Cl. CPC H04L 67/131; G06F 3/165

(57) ABSTRACT

A system can receive, at an extended reality (XR) system worn by a user, a reverberation control signal that is external to media content. The system can generate a reverberation setting comprising a plurality of reverberation parameters utilized to control a simulated reverberation of audio content. The reverberation control signal can tune the reverberation setting for a given application running on the XR system on a per application basis. In some cases, the reverberation setting may be generated based on a video classification, a reverberant characteristic, and/or the reverberation control signal. Other aspects are also described and claimed.

### BACKGROUND

### Related Applications

This application claims the benefit of priority of U.S. Provisional Application No. 63/683,564, filed Aug. 15, 2024, which is herein incorporated by reference.

### Field

This disclosure relates generally to extended reality (XR) and, more specifically, to acoustic optimizations for XR experiences. Other aspects are also described.

### BACKGROUND INFORMATION

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like.

### SUMMARY

Implementations of this disclosure include utilizing a reverberation control signal generated external to media content, such as a user input and/or sensing by the system. The reverberation control signal may be utilized to control or tune a simulated reverberation applied to the media content for a given application running on an XR system worn by the user on a per application basis. In some cases, the reverberation control signal can control or tune a user configurable acoustic setting to customize each of a plurality of applications running on the XR system. The reverberation control signal may be based on an abstraction of one or more reverberation parameters presented to the user. The system can then change the simulated reverberation applied to the media content (e.g., which could be a video, music, or telephony).

As a result, the system can provide a tunable user interface for the user to adjust how audio of the media content may sound when played by a particular application of the XR system. This can enable the user to optimize sound quality, speech intelligibility, etc., as desired, based on the content of the media (which may be captured by a recording) and/or analysis of the environment (room size, doors, windows, and reverberation control signal). In some cases, the system can utilize the reverberation control signal to generate custom sounds (e.g., natural soundscapes, or background sound enhancements), such as by sensing the environment to determine where windows and doors are located, and whether they are open or closed, then augmenting sounds that are occluded by closed windows or doors; or virtually generating sounds so that the closed windows or doors appear to be open.

Some implementations may include a method for acoustic optimization, including receiving, at an extended reality (XR) system worn by a user, a reverberation control signal from a user interface (UI) connected to the XR system, wherein the UI presents to the user an abstraction of one or more reverberation parameters; generating a reverberation setting comprising a plurality of reverberation parameters, wherein the reverberation setting is utilized to control a simulated reverberation of audio content, e.g., via headphones of the XR system, and wherein the reverberation control signal tunes the reverberation setting for a given application running on the XR system; and rendering the audio content with the reverberation setting for the given application to produce the simulated reverberation in an environment of the user.

Some implementations may include a method for acoustic optimization, including determining a video classification from a video portion of a media content and a reverberant characteristic from an audio portion of the media content; receiving, at an XR system worn by a user, a reverberation control signal that is external to the media content; generating a reverberation setting comprising a plurality of reverberation parameters utilized to control a simulated reverberation of the audio portion, e.g., via headphones of the XR system, wherein the reverberation setting is generated based on i) the video classification, ii) the reverberant characteristic, and iii) the reverberation control signal; and rendering the audio portion with the reverberation setting during playback of the media content in an environment of the user. Other aspects are also described and claimed.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the Claims section. Such combinations may have particular advantages not specifically recited in the above summary.

### BRIEF DESCRIPTION OF THE DRAWINGS

Several aspects of the disclosure here are illustrated by way of example and not by way of limitation in the figures of the accompanying drawings in which like references indicate similar elements. It should be noted that references to “an” or “one” aspect in this disclosure are not necessarily to the same aspect, and they mean at least one. Also, in the interest of conciseness and reducing the total number of figures, a given figure may be used to illustrate the features of more than one aspect of the disclosure, and not all elements in the figure may be required for a given aspect.

FIG. 1 is an example of a system providing acoustic optimizations for XR experiences.

FIG. 2 is an example of a user interface connected to an XR system.

FIG. 3 is an example of acoustic optimizations in an environment of a user.

FIG. 4 is an example of a process for acoustic optimizations for XR experiences.

FIG. 5 is an example of another process for acoustic optimizations for XR experiences.

### DETAILED DESCRIPTION

Using either consumer electronic devices or professional recording equipment, individuals and teams can capture two dimensional (2D) or three dimensional (3D) video content. The video files they generate can contain audio tracks that may be either mono, stereo, or spatially encoded (e.g., encoded based on higher order ambisonics, HOA). Video content can then be played back by an application on an XR system as either windowed content, such as watching a 2D or 3D video on a virtual rectangular TV screen, or immersive content, such as a 360° viewing environment where the user feels immersed in the rendering of the video.

Rendering audio for the accompanying video may take different forms. For example, audio rendering may include i) direct-to-headphones mono or stereo rendering of the audio file, ii) point source spatial audio rendering in which audio is positioned at a targeted location, such as the center of the screen or field of view (or as virtual stereo speakers attached to the edges of a virtual screen), or iii) immersive (surround sound) audio rendering in which audio that is spatially encoded in an audio track is positioned in a 3D environment around the user.

Spatial audio rendering refers to a process in which an individual audio track (e.g., mono), or multiple audio tracks encoded in a stereo or spatial audio format, are processed into a binaural (e.g., one channel per ear of the user) audio stream to create an illusion for the user that sound is coming from somewhere in 3D environment (e.g., in front of or all around the user). At a high level, directional information may be encoded in a head-related transfer function (HRTF) portion of the spatial audio rendering process, and the size and timbre of the space in which the audio is playing may be modeled by a reverberation portion of the rendering process.

When rendering spatial audio for captured video content, a subtle or “dry” (reduced) reverberation may be utilized to prevent the spatialization reverberation from clashing with reverberation in the content or otherwise creating a distracting effect. However, when rendering spatial audio, a reverberation that is too subtle or dry may inhibit the illusion that sound is coming from somewhere in space rather than from the headphones (an externalization effect). Also, in some cases a user might want to boost the spatialization reverberation of a room to create an aesthetic “blur” of their content.

Further, while some systems might attempt to achieve reverberation with realism (e.g., faithfully recreating the physics of a space where the system is located), this might not be suitable for all applications running on the system. For example, it may be desirable for some applications to optimize sound effects (e.g., media), or human voice frequency spectrum (e.g., telephony), or narration (e.g., storytelling or meditation), any of which potentially including different reverberations. However, conventional XR systems are often limited in their ability to enable users to customize reverberations in different environments, for different applications, in this way.

Implementations of this disclosure address problems such as these by utilizing a reverberation control signal generated external to media content, such as a user input and/or sensing by the system. The reverberation control signal may be utilized to control or tune a simulated reverberation applied to the media content for a given application running on an XR system worn by the user on a per application basis. In some cases, the reverberation control signal can control or tune a user configurable acoustic setting to customize each of a plurality of applications running on the XR system. The reverberation control signal may be based on a non-technical abstraction of one or more reverberation parameters presented to the user. The system can then change the simulated reverberation applied to the media content (e.g., which could be a video, music, or telephony).

As a result, the system can provide a tunable user interface for the user to adjust how audio of the media content may sound when played by a particular application of the XR system. This can enable the user to optimize sound quality, speech intelligibility, etc., as desired, based on the content of the media (which may be captured by a recording) and/or analysis of the environment (room size, doors, windows, and reverberation control signal). In some cases, the system can utilize the reverberation control signal to generate custom sounds (e.g., natural soundscapes, or background sound enhancements), such as by sensing the environment to determine where windows and doors are located, and whether they are open or closed, then augmenting sounds that are occluded by closed windows or doors; or virtually generating sounds so that the closed windows or doors appear to be open. Other aspects are also described and claimed.

In some implementations, an XR system can apply reverberation estimation to analyze a recorded audio signal to determine reverberant characteristics of the environment in which the recording was taken. The system can also apply video and/or image classification to analyze an image or video signal and assign a categorization for where the recording took place (e.g. indoor versus outdoor, or on a beach, in a classroom, at a park, in a car, etc.). The system can use sensors, such as a camera, microphone, and/or Lidar (light detection and ranging) to estimate the geometry and materials of the environment (e.g., of the physical room) where the user of the XR system is currently located. The system can then generate a simulated reverberation that may be applied to the environment for virtual content.

In some embodiments, based on utilizing reverberation estimation in conjunction with video and/or image classification, media content of an audio/video file may be analyzed and output to a series of heuristics to determine optimal reverberation settings to use for rendering the media content. This may include simulating reverberation and/or accessing a look up table in runtime to match an estimated real-world space of the environment. The simulated reverberation may comprise a collection of parameters used to dynamically synthesize the reverberation using virtual acoustic simulation. In some cases, reverberation settings may be input to a lookup table to determine an optimal reverberation preset from a library. As a result, the simulated reverberation experienced by the user can achieve an optimal balance between externalization, immersivity, and faithfulness to the original content.

In some embodiments, a reverberation setting may comprise a collection of parameters used to dynamically synthesize a reverberation using virtual acoustic simulation. In some cases, the reverberation setting may be input to a lookup table to determine an optimum reverberation preset from a library. A reverberation control signal, which may comprise one or more parameters external to the audio/video content, may be utilized when selecting the reverberation setting. For example, the reverberation control signal may include reverberation characteristics of the actual room or environment where the user of the system is presently located, sensed or detected by the XR system. In some cases, the reverberation control signal may include input from the user, such as a playback volume level, level of immersion (e.g., MR vs. full VR), apparent virtual size of a video playback window, distance of a video playback window from the user, and/or a visual rendering configuration of the media (e.g., a portal mode vs. fully immersive mode).

Several aspects of the disclosure with reference to the appended drawings are now explained. Whenever the shapes, relative positions and other aspects of the parts described are not explicitly defined, the scope of the invention is not limited only to the parts shown, which are meant merely for the purpose of illustration. Also, while numerous details are set forth, it is understood that some aspects of the disclosure may be practiced without these details. In other instances, well-known circuits, structures, and techniques have not been shown in detail so as not to obscure the understanding of this description.

With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, organic light-emitting diodes (OLEDs), LEDs, microLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

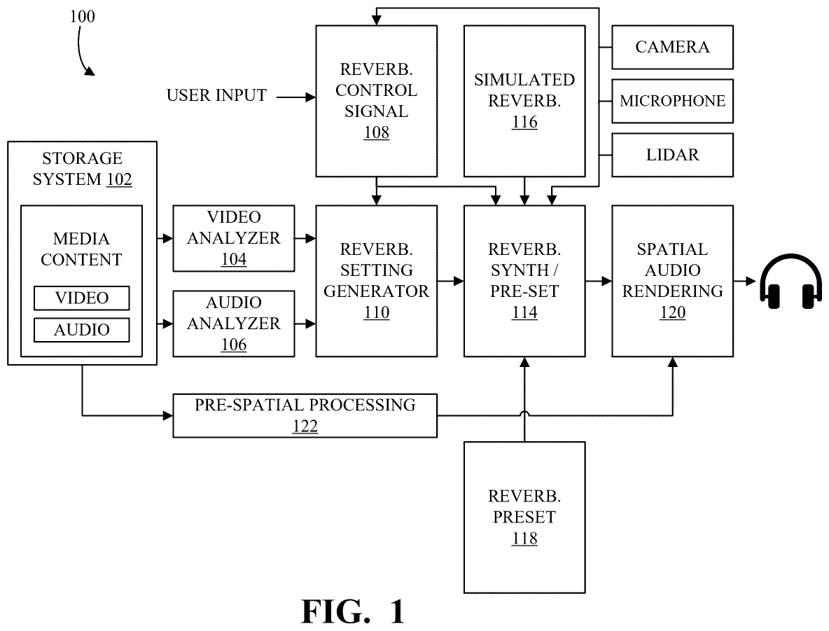

FIG. 1 is an example of a system 100 providing acoustic optimizations for XR experiences. The system 100 may be part of an XR system worn by a user, including headphones, microphones, sensors, and a video display. The system 100 may include a storage system 102 for storing or buffering media content including a video portion and an audio portion. For example, the media content could be an audio/video media file that is stored locally or streamed. The system 100 may also include a video analyzer 104 and an audio analyzer 106. The video analyzer 104 can analyze the video portion of the media content to determine a video classification representing the environment in which the recording was taken. For example, the video analyzer 104 can utilize a video estimation algorithm to analyze the recorded video signal (represented by the video portion) and assign a categorization for where the recording took place, such as indoor versus outdoor, on a beach, in a classroom, at a park, in a car, etc. Thus, the video classification may be internal to, or dependent on, the video portion of the media content.

The audio analyzer 106 can also analyze the audio portion of the media content to determine a reverberant characteristic from the audio portion representing the environment in which the recording was taken. For example, the audio analyzer 106 can utilize a reverberation estimation algorithm to analyze a recorded audio signal (represented by the audio portion) to determine one or more reverberant characteristics, such as reverberation time, reverberation strength, direct send level, reverberant send level, room size, absorption coefficient, and/or scattering coefficient. Thus, the reverberant characteristic may be internal to, or dependent on, the audio portion of the media content.

The system 100 may also receive a reverberation control signal 108 generated external to the media content (e.g., independent of the media content in the storage system 102). In some cases, the reverberation control signal 108 may be generated via a UI connected to the system 100. The UI can present to the user an abstraction of one or more reverberation parameters. The abstraction may be a non-technical abstraction based on size, color, mood, etc. For example, the abstraction may include “wetness” versus “dryness” for controlling parameters such as RT60 and reverberation strength, absorption, and scattering; or “brightness” versus “darkness” for controlling parameters such as high frequency in absorption/scattering on materials. In some cases, the reverberation control signal 108 may be generated via a remote control operated by the user (physical or virtual). In some cases, the reverberation control signal 108 may be generated via an authoring tool or other program. In some cases, the reverberation control signal 108 may be generated via sensing (e.g., camera, microphone, Lidar). The reverberation control signal 108 can tune a reverberation setting, generated by a reverberation setting generator 110 of the system 100, for a given application running on the XR system. The reverberation control signal 108 can customize a simulated reverberation for the specific application generated by a reverberation synthesizer 114 of the system 100.

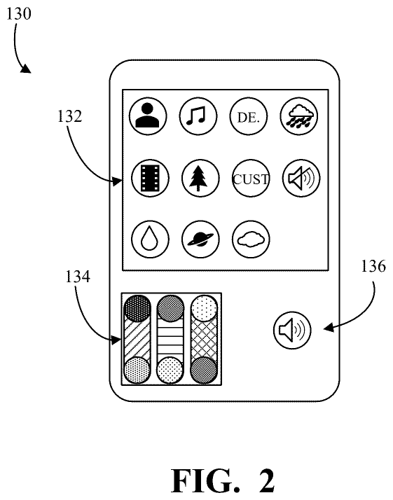

By way of example, with additional reference to FIG. 2, a UI 130 may be connected to the system 100. The UI 130 may be a remote control operated by the user. In some cases, the remote control may be a virtual remote control presented in the XR environment of the user (e.g., an application window UI panel). In other cases, the remote control may be a physical remote control held by the user, e.g., wirelessly connected to the system 100.

The UI 130 may enable the reverberation control signal 108 to be generated by the user in a simplified way in which one or more abstractions may correspond to one or more reverberation parameters of the plurality of reverberation parameters as presented to the user (as opposed to presenting technical parameters directly). For example, the plurality of reverberation parameters may include technical parameters, such as a reverberation time, reverberation strength, direct send level, reverberant send level, room size, absorption coefficient, and/or scattering coefficient. In some cases, the UI 130 may include buttons 132 with presets and/or sliders 134 for adjusting the reverberation setting via the parameters, such as a spatialization palate analogous to a dimmer switch for a light. In some cases, the buttons 132 may include automatic presets for various desired optimization, such as for presets for human voice, music, movies, natural, underwater, silent/space, dereverberation, custom presets, enhanced background/outside, added background noise (sound-designed ambiences), etc. In some cases, the presets can optimize sound quality for various conditions, such as sound effects (e.g., media), human voice frequency spectrum (e.g., telephony), or narration (e.g., storytelling or meditation), each of which potentially involving different reverberations. The sliders 134 can indicate abstractions of infinitely adjustable reverberation qualities to simplify adjustment of reverberations for the user (e.g., more reverberation versus less reverberation on a sliding scale). For example, this may include indications such as “wetness” versus “dryness” (for controlling RT60 and reverberation strength, or absorption and scattering), “brightness” versus “darkness” (for controlling high frequency in absorption/scattering on materials), “warmth,” etc. The UI 130 may also enable size adjustment, direct send, and/or reverberation send keys, corresponding to one or more of the plurality of reverberation parameters.

Thus, a single input of the UI 130 by the user can simultaneously adjust and control a plurality of reverberation parameters to tune the reverberation setting. Adjustments via the one or more abstractions may also include limits (e.g., ceilings/floors) on the reverberation parameters so that a minimum quality of spatialization can be maintained. A speaker button 136 may also enable the user to provide a manual placement of virtual speakers in the environment (e.g., manual placement of virtual sources).

Referring again to FIG. 1, in some cases, the reverberation control signal 108 (generated from sources external to the media content itself, such as user input) may also indicate sensed or detected conditions in the environment. For example, the reverberation control signal 108 could indicate a detected reverberation characteristic of the physical environment (measured in sampled in the room via the camera, microphone, and/or Lidar), a playback volume or a selected level of immersion of the XR system, a virtual size of a playback window, a distance between the playback window and the user, and/or whether a window or door is opened or closed. The reverberation setting may be tuned based on the sensed or detected conditions via the reverberation control signal 108. In some cases, an acoustic parameter of the user's physical (real) ambient environment, such as an RT60 parameter, which may be determined based on having sensed sound in the room using one or more microphones, or based on receiving the size, materials and obstacles in the room (e.g., as sensed by a camera that may be integrated in the XR system worn by the user, such as headphones or an XR headset) may be used to provide the reverberation control signal 108.

Thus, the system 100 may utilize the reverberation setting generator 110 to generate a reverberation setting with an acoustic optimization for the XR system. The reverberation setting may comprise the plurality of reverberation parameters (e.g., the reverberation time, reverberation strength, direct send level, reverberant send level, room size, absorption coefficient, and/or scattering coefficient). In some cases, the plurality of reverberation parameters may be adapted from detected, actual reverberation parameters in the physical environment of the user. The plurality of reverberation parameters may be utilized to control the simulated reverberation (generated by the reverberation synthesizer 114) via headphones of the system 100 on a per application basis (e.g., specific to each application or media content that may be running). The reverberation settings, configured via the plurality of reverberation parameters, may be continuously updated to dynamically synthesize reverberation over time using virtual acoustic simulation, and/or a lookup table to determine an optimum reverberation preset from a library, for each application.

The parameters may include reverberation characteristics of the actual room or environment where the user of the system 100 is presently located, system 100 playback volume level or level of immersion (e.g., MR vs. full VR), apparent virtual size of a video playback window, distance of the video playback window from the user, and/or visual rendering configuration of the media (e.g., a portal mode vs. fully immersive mode). The reverberation control signal 108 can tune the reverberation setting for the given application running on the system 100. In some implementations, the reverberation setting may be generated based on the video classification from the video analyzer 104, the reverberant characteristic from the audio analyzer 106, and/or the reverberation control signal 108. In some implementations, the reverberation setting generator 110 may comprise a series of heuristics to determine optimal reverberation settings to use for rendering the media content. This may include generating an output to enable simulating a reverberation or accessing a look up table in runtime to suit the real-world space of the environment via the reverberation synthesizer 114. In some implementations, the reverberation setting may be saved as a preset that is accessible to the user through the UI 130 (e.g., saved to one of the buttons 132).

The system 100 may also utilize a camera, microphone, and/or Lidar to estimate a geometry and materials of the environment (e.g., physical room) where the user of the system 100 is currently located. The system 100 can utilize the reverberation synthesizer 114, based on the reverberation setting, to generate a simulated reverberation 116 to apply to the environment for the media content. In some cases, the reverberation setting, including the plurality of reverberation parameters, may be used to synthesize the simulated reverberation based on machine learning or acoustic ray tracing. In some cases, the reverberation setting, including the plurality of reverberation parameters, may be used to look up a reverberation preset 118 for the simulated reverberation from a library.

The system 100 may then utilize a spatial audio renderer 120 to render audio content (e.g., the audio portion of the media content) with the reverberation setting for the given application running on the XR system. For example, the system can render audio content via headphones of the XR system worn by the user during playback of the media content. The spatial audio renderer 120 may process the audio content into a binaural (e.g., one channel per ear of the user) audio stream to create an illusion for the user that sound is coming from somewhere in the 3D environment (e.g., in front of or all around the user). The audio content may be rendered with acoustic optimizations to improve XR experiences for the user.

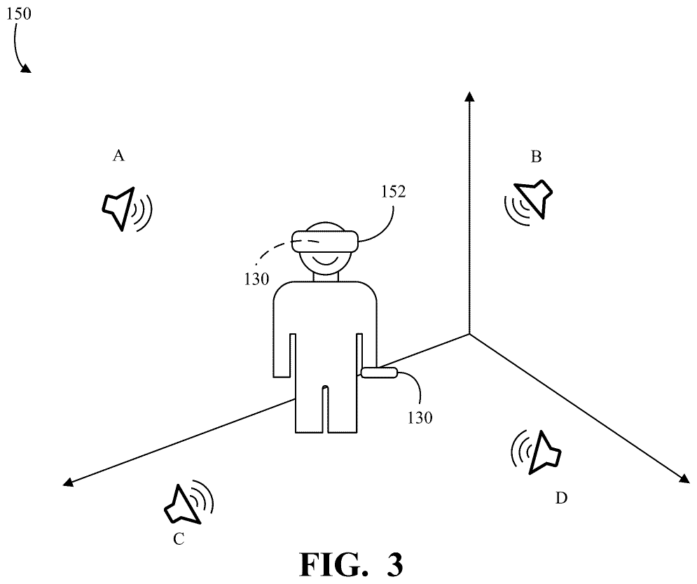

For example, the audio portion of the media content may be rendered during playback of the video portion of the media content by the XR system as windowed or immersive content. With additional reference to FIG. 3, the audio content may be rendered with acoustic optimizations to improve XR experiences by the user in an environment 150. The user may be wearing an XR system including the system 100 implemented by a head mounted display (HMD) 152. The user may also be accessing the UI 130 via a remote control (e.g., an application window UI panel, indicated by a dashed line, and/or a handheld wireless controller indicated by a solid line). The acoustic optimizations provided by the system 100 may result in one or more virtual sources (e.g., virtual speakers A to D, providing immersive surround sound rendering, one or more of which may be manually placed at targeted locations in the environment by the user via button 136 of the UI 130) appearing to the user to be distributed in the environment 150 to achieve the desired simulated reverberation for the media content of the application.

In some implementations, the system 100 may also perform pre-spatial processing 122 with the audio content before rendering with the reverberation setting. For example, the pre-spatial processing 122 could implement a de-reverberation, or up-mixing associated with the content, including as selected via the UI 130.

As a result, the system 100 can generate a simulated reverberation to achieve an optimal balance between externalization, immersivity, and faithfulness to the original content with input from the user. The system 100 can utilize the reverberation control signal 108, generated external to media content, to control the simulated reverberation, based on the environment (e.g., physical room) of the user, for the given application running on the XR system worn by the user. The reverberation control signal 108 can provide a user configurable acoustic setting to customize each application running on the XR system with its own reverberation setting. This may enable the system 100 to change reverberation in the user's environment (e.g., the room in which the user is located) for virtual sources to be played back by the application. Thus, the system 100 can provide tunable user interface parameters for the user to adjust how audio sounds when played by the system 100. This can enable the user to optimize sound quality, speech intelligibility, etc., as desired, based on the contents of the media content (captured by the recording) and the analysis of the environment (room size, doors, windows, and reverberation control signal) where the user is located.

In some cases, the system 100 can generate custom sounds (e.g., natural soundscapes, or background sound enhancements), such as by utilizing a scan of the environment to determine where windows and doors are located, and whether they are open or closed, and by augmenting sounds that are occluded by closed windows or doors, or virtually generating sounds so that the closed windows or doors appear to be open.

As described above, the system 100 may include a connection to a headphone. The headphone could be an over-car, on-car, loose fitting earbud, or sealing in-car headphone. In some cases, the system 100 may include the simulated reverberation to the headphone with real-world sounds in the physical environment, such as speech or background noise in the environment. This may provide an improved noise cancellation or transparency mode for the user. For example, in some cases, the system 100 may include the simulated reverberation with real-world speech of another person nearby in the physical environment (e.g., speech not generated by the headphone). This may provide a noise cancellation mode (cancellation of background noise). In another example, in some cases, the system 100 may include the simulated reverberation to augment real-world background noise in the physical environment (e.g., noise which might normally be filtered out, or go directly to the user's ear unmodified). This may provide a transparency mode.

Reference is now made to flowcharts of examples of processes for performing passive hearing tests. The processes can be executed using computing devices, such as the systems, hardware, and software described with respect to FIGS. 1-3. The processes can be performed, for example, by executing a machine-readable program or other computer-executable instructions, such as routines, instructions, programs, or other code. The operations of the processes or other techniques, methods, or algorithms described in connection with the implementations disclosed herein can be implemented directly in hardware, firmware, software executed by hardware, circuitry, or a combination thereof.

For simplicity of explanation, the processes are depicted and described herein as a series of operations. However, the operations in accordance with this disclosure can occur in various orders and/or concurrently. Additionally, other operations not presented and described herein may be used. Furthermore, not all illustrated operations may be required to implement a process in accordance with the disclosed subject matter.

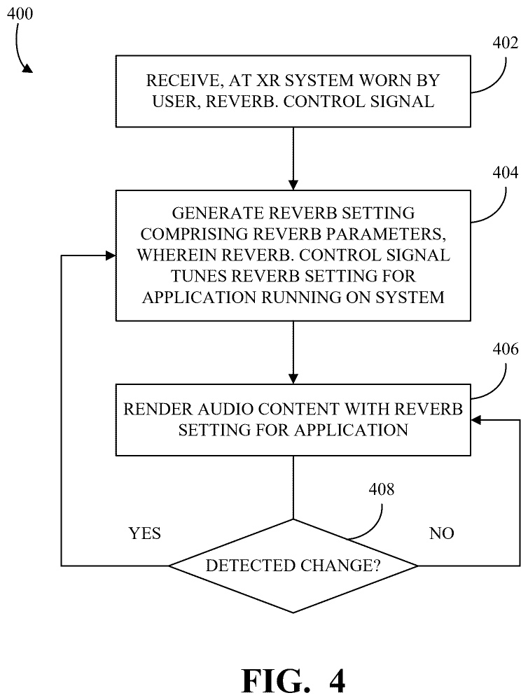

FIG. 4 is an example of a process 400 for acoustic optimizations for XR experiences. At operation 402, a system can receive, at an XR system worn by a user, a reverberation control signal from a UI connected to the XR system. The XR system may include headphones (e.g., extra aural), an AR, VR, or MR video display, and sensors (e.g., a camera, microphone, and/or Lidar). The UI can present to the user an abstraction of one or more reverberation parameters. For example, the XR system 100, worn by the user, can receive the reverberation control signal 108 external to the media content, such as via the UI 130 connected to the system. In some cases, when receiving via the UI 130, the reverberation control signal may be generated by a remote control that may be held and operated by the user. In some cases, the reverberation control signal may be generated via an authoring tool or other program.

At operation 404, the system can generate a reverberation setting comprising a plurality of reverberation parameters. The reverberation setting may be utilized to control a simulated reverberation (e.g., applied to an audio signal for audio content, such as a video, music, or telephony) of a user via headphones of the XR system. For example, the reverberation setting generator 110 can generate the reverberation setting based on the reverberation control signal. The plurality of reverberation parameters may include a reverberation time, reverberation strength, direct send level, reverberant send level, room size, absorption coefficient, and/or scattering coefficient associated with an environment of the user, such as the environment 150. The reverberation control signal may tune the reverberation setting for a given application running on the XR system. For example, multiple applications may be running on the system, and each application may have its own reverberation setting that is tuned for the user based on the reverberation control signal.

At operation 406, the system can render audio content with the reverberation setting for the given application to produce the simulated reverberation in the environment of the user. For example, the spatial audio renderer 120 can render the audio content (e.g., an audio portion of a media content, which may include a video portion as well) with the reverberation setting for the given application running on the XR system. The system can render the audio content via headphones of the XR system worn by the user during playback of the media content. The audio content may be rendered with acoustic optimizations to improve XR experiences for the user. For example, the acoustic optimizations may result in virtual sources (e.g., virtual speakers A to D) appearing to the user to be distributed in the environment of the user to achieve the desired reverberation.

At operation 408, the system can determine whether there is a detected change to the reverberation control signal, such as a change in the same reverberation control signal that was previously sent or receiving an additional reverberation control signal. If there is no change to the reverberation control signal (“No”), the system can continue to render the audio content at operation 406. However, if there is a change to the reverberation control signal (“Yes”), the system can return to operation 404 to further tune the reverberation setting based on the change.

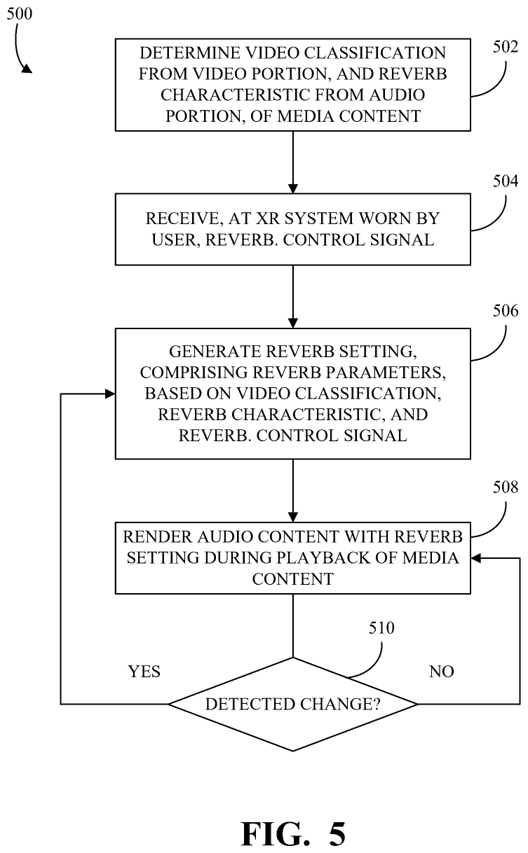

FIG. 5 is example of a process 500 for acoustic optimizations for XR experiences. At operation 502, a system can determine a video classification from a video portion of a media content and a reverberant characteristic from an audio portion of the media content. For example, the XR system 100, worn by the user, can utilize the video analyzer 104 and the audio analyzer 106 to determine a video classification from a video portion of a media content and a reverberant characteristic from an audio portion of the media content, respectively.

At operation 504, the system can receive, at the XR system worn by the user, a reverberation control signal that is external to the media content. For example, the XR system may include headphones (e.g., extra aural), an AR, VR, or MR video display, and sensors (e.g., a camera, microphone, and/or Lidar). The XR system 100, worn by the user, can receive the reverberation control signal 108 by the UI 130 and/or by sensing. For example, in some cases, the reverberation control signal may be generated via a UI connected to the system, such as a remote control operated by the user, or via an authoring tool or other program. In some cases, the reverberation control signal may be generated via sensing, such as the camera, microphone, and/or Lidar of the system.

At operation 506, the system can generate a reverberation setting comprising a plurality of reverberation parameters utilized to control a simulated reverberation of audio content or an audio portion of media content via headphones of the XR system. The reverberation setting is generated based on i) the video classification, ii) the reverberant characteristic, and iii) the reverberation control signal. For example, the reverberation setting generator 110 can generate the reverberation setting based on the reverberation control signal. The plurality of reverberation parameters may include a reverberation time, reverberation strength, direct send level, reverberant send level, room size, absorption coefficient, and/or scattering coefficient associated with an environment of the user, such as the environment 150. The reverberation setting may be generated based on the video classification from the video analyzer 104, the reverberant characteristic from the audio analyzer 106, and the reverberation control signal 108 from the UI (e.g., the remote control, or the authoring tool or other program). One or more of the video classification, the reverberant characteristic, and/or the reverberation control signal may be used to tune the reverberation setting for a given application running on the XR system. For example, multiple applications may be running on the system, and each application may have its own reverberation setting that is tuned for the user based on one or more of the video classification, the reverberant characteristic, and/or the reverberation control signal.

At operation 508, the system can render the audio portion with the reverberation setting during playback of the media content in an environment of the user. For example, the spatial audio renderer 120 can render the audio content (e.g., an audio portion of a media content) with the reverberation setting during playback of the media content on the XR system. The system can render the audio content via headphones of the XR system worn by the user during playback of the media content. The audio content may be rendered with acoustic optimizations to improve XR experiences for the user. For example, the acoustic optimizations may result in virtual sources (e.g., virtual speakers A to D) appearing to the user to be distributed in the environment of the user to achieve the desired reverberation.

At operation 510, the system can determine whether there is a detected change to one or more of the video classification, the reverberant characteristic, and/or the reverberation control signal. If there is no change (“No”), the system can continue to render the audio content at operation 406. However, if there is a change (“Yes”), the system can return to operation 404 to further tune the reverberation setting based on the change.

As described above, one aspect of the present technology is the gathering and use of data available from specific and legitimate sources for acoustic optimizations for XR experiences. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used for acoustic optimizations for XR experiences. Accordingly, use of such personal information data enables users to have greater control of the delivered content.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, such as in the case of acoustic optimizations for XR experiences, the present technology can be configured to allow users to select to “opt in” or “opt out” of participation in the collection of personal information data during registration for services or anytime thereafter.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

In utilizing the various aspects of the embodiments, it would become apparent to one skilled in the art that combinations or variations of the above embodiments are possible for acoustic optimizations for XR experiences. Although the embodiments have been described in language specific to structural features and/or methodological acts, it is to be understood that the appended claims are not necessarily limited to the specific features or acts described. The specific features and acts disclosed are instead to be understood as embodiments of the claims useful for illustration.

What is claimed is:

1. A method for acoustic optimization, comprising:
receiving, at an extended reality (XR) system worn by a user, a reverberation control signal from a user interface (UI) connected to the XR system, wherein the UI presents to the user an abstraction of one or more reverberation parameters;
generating a reverberation setting comprising a plurality of reverberation parameters, wherein the reverberation setting is utilized to control a simulated reverberation of audio content, and wherein the reverberation control signal tunes the reverberation setting for a given application running on the XR system; and
rendering the audio content with the reverberation setting for the given application to produce the simulated reverberation to the user.

2. The method of claim 1, wherein the reverberation control signal is generated via a remote control operated by the user.

3. The method of claim 1, wherein a single input of the UI by the user simultaneously adjusts a plurality of reverberation parameters.

4. The method of claim 1, wherein the abstraction indicates one or more of wetness versus dryness, brightness versus darkness, or warmth corresponding to the one or more reverberation parameters.

5. The method of claim 1, wherein the reverberation control signal is generated via an authoring tool that customizes the simulated reverberation for each application of a plurality of applications.

6. The method of claim 1, wherein the plurality of reverberation parameters includes at two or more of a reverberation time, reverberation strength, direct send level, reverberant send level, room size, absorption coefficient, or scattering coefficient.

7. The method of claim 1, wherein the plurality of reverberation parameters is used to synthesize the simulated reverberation based on machine learning or acoustic ray tracing.

8. The method of claim 1, wherein the plurality of reverberation parameters is used to look up a reverberation preset for the simulated reverberation.

9. The method of claim 1, wherein the simulated reverberation is included with real-world speech of another person in a physical environment in a noise cancellation mode.

10. The method of claim 1, wherein the simulated reverberation is included to augment real-world background noise in a physical environment in a transparency mode.

11. A method for acoustic optimization, comprising:
determining a video classification from a video portion of a media content and a reverberant characteristic from an audio portion of the media content;
receiving, at an extended reality (XR) system worn by a user, a reverberation control signal that is external to the media content;
generating a reverberation setting comprising a plurality of reverberation parameters utilized to control a simulated reverberation of the audio portion, wherein the reverberation setting is generated based on i) the video classification, ii) the reverberant characteristic, and iii) the reverberation control signal; and
rendering the audio portion with the reverberation setting during playback of the media content to the user.

12. The method of claim 11, wherein the reverberation control signal is generated via a user interface (UI) that enables the user to tune the simulated reverberation for a given application playing the media content.

13. The method of claim 11, wherein the reverberation control signal is generated via a tool that customizes the simulated reverberation for a given running on the XR system.

14. The method of claim 11, wherein the reverberation control signal indicates a reverberation characteristic of the environment.

15. The method of claim 11, wherein the reverberation control signal indicates a playback volume or a selected level of immersion.

16. The method of claim 11, wherein the reverberation control signal indicates a virtual size of a playback window or a distance between the playback window and the user.

17. The method of claim 11, wherein the reverberation control signal indicates a window or door being opened or closed.

18. The method of claim 11, wherein the reverberation parameters are adapted from detected reverberation parameters in the environment.

19. The method of claim 11, further comprising:
saving the reverberation setting as a preset that is accessible to the user through a UI connected to the XR system.

20. The method of claim 11, wherein the audio portion is rendered during playback of the video portion by the XR system as windowed or immersive content.
